(19) United States
(12) Patent Application Publication
(10) Pub. No.: US 2007/0055520 A1
(43) Pub. Date: Mar. 8, 2007

(54) Incorporation of speech engine training into interactive user tutorial

(75) Inventors: David Mowatt, Seattle, WA (US); Felix G.T.I. Andrew, Redmond, WA (US); James D. Jacoby, Snohomish, WA (US); Oliver Scholz, Kirkland, WA (US); Paul A. Kennedy, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/265,726

(22) Filed: Nov. 2, 2005

Related U.S. Application Data
(60) Provisional application No. 60/712,873, filed on Aug. 31, 2005.

(51) Int. Cl. G10L 15/04

(52) U.S. Cl. 704/251

(57) ABSTRACT

The present invention combines speech recognition tutorial training with speech recognizer voice training. The system prompts the user for speech data and simulates, with predefined screenshots, what happens when speech commands are received. At each step in the tutorial process, when the user is prompted for an input, the system is configured such that only a predefined set (which may be one) of user inputs will be recognized by the speech recognizer. When a successful recognition is being made, the speech data is used to train the speech recognition system.

The present application is based on and claims the benefit of U.S. provisional patent application Ser. No. 60/712,873, filed Aug. 31, 2005, the content of which is hereby incorporated by reference in its entirety.

### BACKGROUND

Users of current speech recognition systems face a number of problems. First, the users must become familiar with the speech recognition system, and learn how to operate the speech recognition system. In addition, the users must train the speech recognition system to better recognize the user's speech.

To address the first problem (teaching users to use the speech recognition system) current speech recognition tutorial systems attempt to teach the user about the workings of the speech recognizer using a variety of different means. For instance, some systems use tutorial information in the form of help documentation, which can either be electronic or paper documentation, and simply allow the user to read through the help documentation. Still other tutorial systems provide video demonstrations of how users can use different features of the speech recognition system.

Thus, current tutorials do not offer a hands-on experience in which the user can try out speech recognition in a safe, controlled environment. Instead, they only allow the user to watch, or read through, tutorial content. However, it has been found that where a user is simply asked to read tutorial content, even if it is read aloud, the user's retention of meaningful tutorial content is extremely low, bordering on insignificant.

In addition, current speech tutorials are not extensible by third parties. In other words, third party vendors must typically create separate tutorials, from scratch, if they wish to create their own speech commands or functionality, add speech commands or functionality to the existing speech system, or teach existing or new features of the speech system which are not taught by current tutorials.

In order to address the second problem (training the speech recognizer to better recognize the speaker) a number of different systems have also been used. In all such systems, the computer is first placed in a special training mode. In one prior system, the user is simply asked to read a given quantity of predefined text to the speech recognizer, and the speech recognizer is trained using the speech data acquired from the user reading that text. In another system, the user is prompted to read different types of text items, and the user is asked to repeat certain items which the speech recognizer has difficulty recognizing.

In one current system, the user is asked to read the tutorial content out loud, and the speech recognition system is activated at the same time. Therefore, the user is not only reading tutorial content (describing how the speech recognition system works, and including certain commands used by the speech recognition system), but the speech recognizer is actually recognizing the speech data from the user, as the tutorial content is read. The captured speech data is then used to train the speech recognizer. However, in that system, the full speech recognition capability of the speech recognition system is active. Therefore, the speech recognizer can recognize substantially anything in its vocabulary, which may typically include thousands of commands. This type of system is not very tightly controlled. If the speech recognizer recognizes a wrong command, the system can deviate from the tutorial text and the user can become lost.

Therefore, current speech recognition training systems require a number of different things to be effective. The computer must be in a special training mode, have high confidence that the user is going to say a particular phrase, and be actively listening for only a couple of different phrases.

It can thus be seen that speech engine training and user tutorial training address separate problems but are both required for the user to have a successful speech recognition experience.

The discussion above is merely provided for general background information and is not intended to be used as an aid in determining the scope of the claimed subject matter.

### SUMMARY

The present invention combines speech recognition tutorial training with speech recognizer voice training. The system prompts the user for speech data and simulates, with predefined screenshots, what happens when speech commands are received. At each step in the tutorial process, when the user is prompted for an input, the system is configured such that only a predefined set (which may be one) of user inputs will be recognized by the speech recognizer. When a successful recognition is being made, the speech data is used to train the speech recognition system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

### BRIEF DESCRIPTION OF THE DRAWINGS

FIG. 1 is an exemplary environment in which the present invention can be used.

FIG. 2 is a more detailed block diagram of a tutorial system in accordance with one embodiment of the present invention.

FIG. 3 is a flow diagram illustrating one embodiment of the operation of the tutorial system shown in FIG. 2.

FIG. 4 illustrates one exemplary navigation hierarchy.

FIGS. 5-11 are screenshots illustrating one illustrative embodiment of the system shown in FIG. 2.

Appendix A illustrates one exemplary tutorial flow schema used in accordance with one embodiment of the present invention.

### DETAILED DESCRIPTION

The present invention relates to a tutorial system that teaches a user about a speech recognition system, and that also simultaneously trains the speech recognition system based on voice data received from the user. However, before describing the present invention in more detail, one illustrative environment in which the present invention can be used will be described.

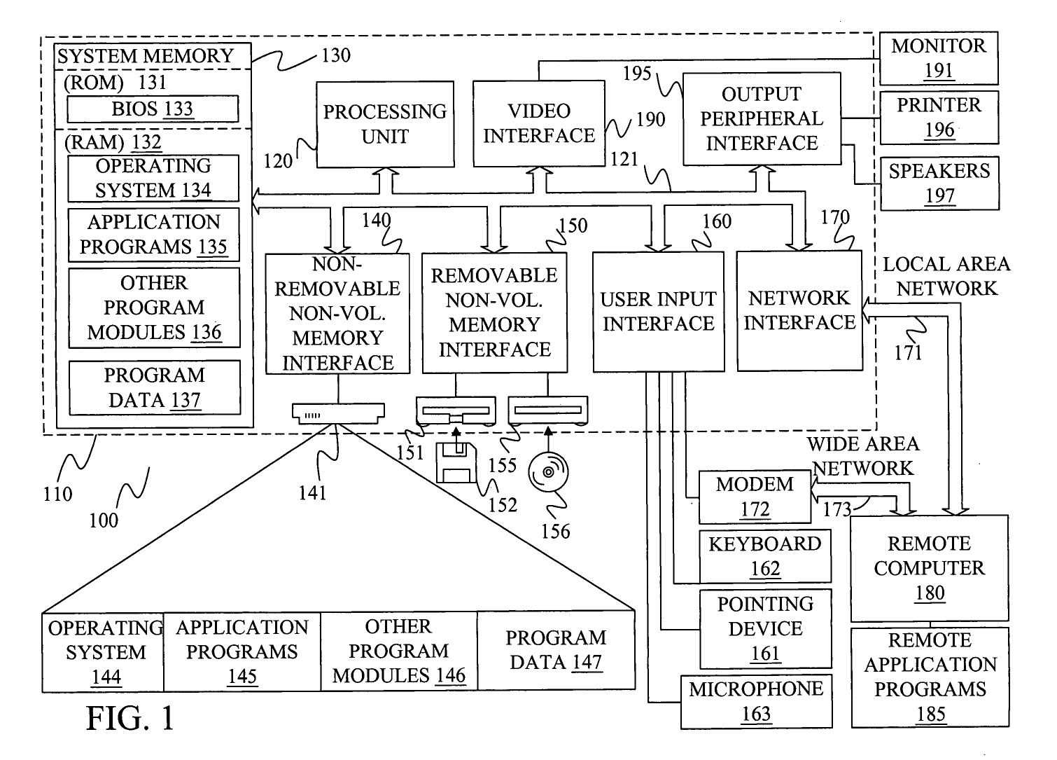

FIG. 1 illustrates an example of a suitable computing system environment 100 on which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

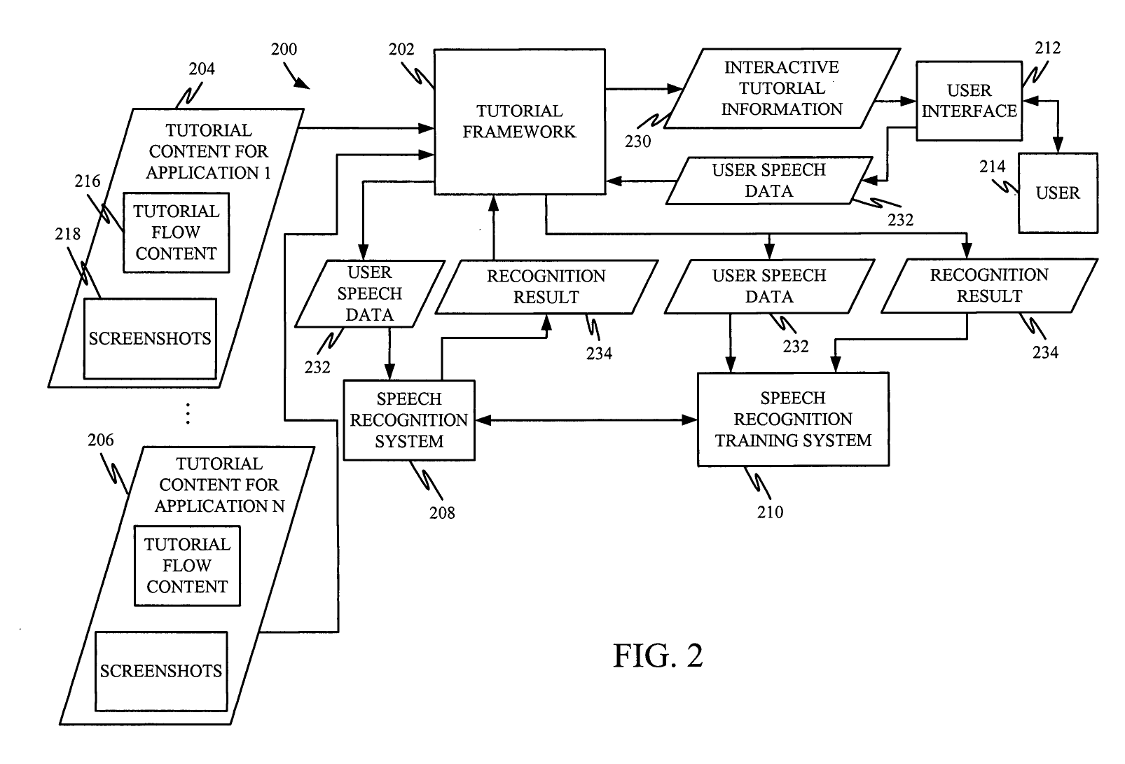

FIG. 2 is a more detailed block diagram of a tutorial system 200 in accordance with one embodiment. Tutorial system 200 includes tutorial framework 202 that accesses tutorial content 204, 206 for a plurality of different tutorial applications. FIG. 2 also shows tutorial framework 202 coupled to speech recognition system 208, speech recognition training system 210, and user interface component 212. Tutorial system 200 is used to not only provide a tutorial to a user (illustrated by numeral 214) but to acquire speech data from the user and train speech recognition system 208, using speech recognition training system 210, with the acquired speech data.

Tutorial framework 202 provides interactive tutorial information 230 through user interface component 212 to the user 214. The interactive tutorial information 230 walks the user through a tutorial of how to operate the speech recognition system 208. In doing so, the interactive tutorial information 230 will prompt the user for speech data. Once the user says the speech data, it is acquired, such as through a microphone, and provided as a user input 232 to tutorial framework 202. Tutorial framework 202 then provides the user speech data 232 to speech recognition system 208, which performs speech recognition on the user speech data 232. Speech recognition system 208 then provides tutorial framework 202 with speech recognition results 234 that indicate the recognition (or non-recognition) of the user speech data 232.

In response tutorial framework 202 provides another set of interactive tutorial information 230 to user 214 through user interface component 212. If the user speech data 232 was accurately recognized by speech recognition system 208, then the interactive tutorial information 230 shows the user what happens when the speech recognition system receives that input. Similarly, if the user speech data 232 is not recognized by speech recognition system 208, then the interactive tutorial information 230 shows the user what happens when a non-recognition occurs at that step in the speech recognition system. This continues for each step in the tutorial application that is currently running.

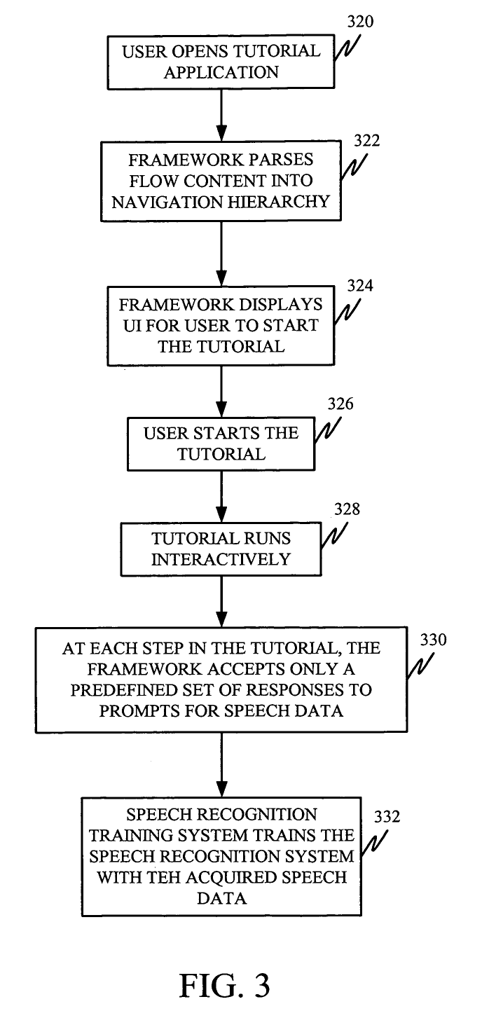

FIG. 3 is a flow diagram better illustrating how system 200, shown in FIG. 2, operates in accordance with one embodiment. Prior to describing the operation of system 200 in detail, it will first be noted that a developer who wishes to provide a tutorial application that teaches about a speech recognition system will first have generated tutorial content such as tutorial content 204 or 206. For purposes of the present discussion, it will be assumed that the developer has generated tutorial content 204 for application one.

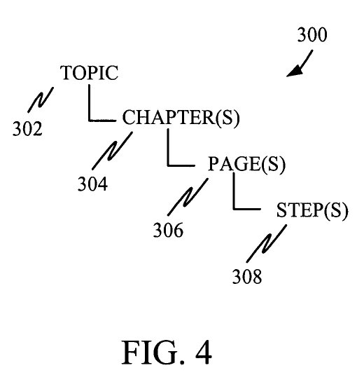

The tutorial content illustratively includes tutorial flow content 216 and a set of screenshots or other user interface display elements 218. Tutorial flow content 216 illustratively describes the complete navigational flow of the tutorial application as well as the user inputs which are allowed at each step in that navigational flow. In one embodiment, tutorial flow content 216 is an XML file that defines a navigational hierarchy for the application. FIG. 4 illustrates one exemplary navigational hierarchy 300 which can be used. However, the navigation need not necessarily be hierarchical, and other hierarchies or even a linear set of steps (rather than a hierarchy) could be used as well.

In any case, the exemplary navigation hierarchy 300 shows that the tutorial application includes one or more topics 302. Each topic has one or more different chapters 304 and can also have pages. Each chapter has one or more different pages 306, and each page has zero or more different steps 308 (An example of a page with zero steps might be an introduction page with no steps). The steps are steps which are to be taken by the user in order to navigate through a given page 306 of the tutorial. When all of the steps 308 for a given page 306 of the tutorial have been completed, the user is provided with the option to move on to another page 306. When all the pages for a given chapter 304 have been completed, the user is provided with an option to move on to a subsequent chapter. Of course, when all of the chapters of a given topic have been completed, the user can then move on to another topic of the tutorial. It will also be noted, of course, that the user may be allowed to skip through different levels of the hierarchy, as desired by the developer of the tutorial application.

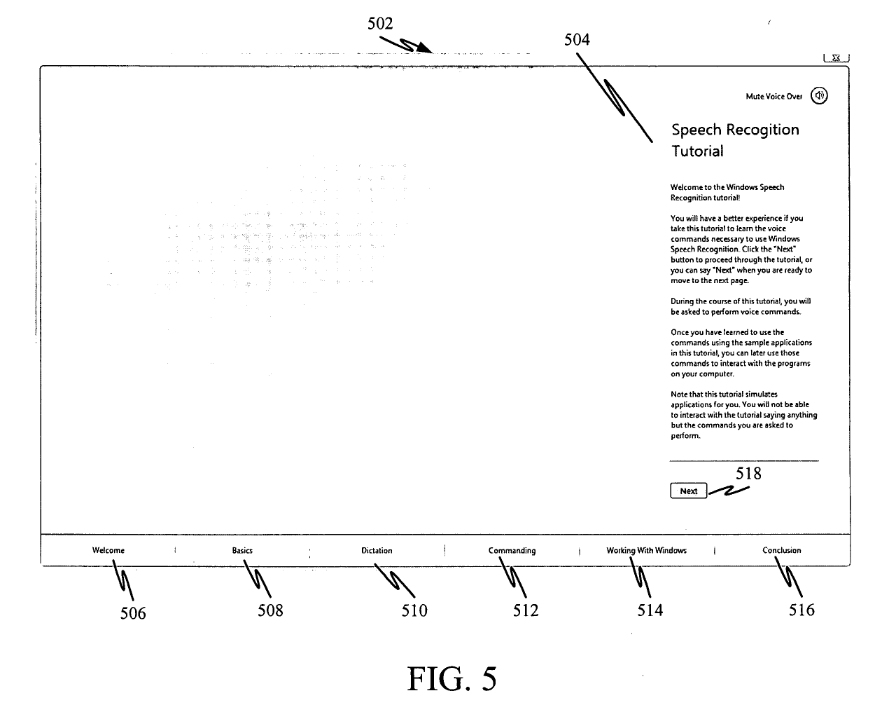

One concrete example of a tutorial flow content 216 is attached to the application as Appendix A. Appendix A is a XML file which completely defines the flow of the tutorial application according to the navigational hierarchy 300 shown in FIG. 4. The XML file in Appendix A also defines the utterances that the user is allowed to make at any given step 308 in the tutorial, and defines or references a given screenshot 218 (or other text or display item), that is to be displayed in response to a user saying a predefined utterance. Some exemplary screenshots will be discussed below with respect to FIGS. 5-11.

Once this tutorial content 204 has been generated by a developer (or other tutorial author), the tutorial application for which tutorial content 204 has been generated can be run by system 200 shown in FIG. 2. One embodiment of the operation of system 200 in running the tutorial is illustrated by the flow diagram in FIG. 3.

The user 214 first opens the tutorial application one. This is indicated by block 320 in FIG. 3 and can be done in a wide variety of different ways. For instance, user interface component 212 can display a user interface element which can be actuated by the user (such as using a point and click device, or by voice, etc.) in order to open the given tutorial application.

Once the tutorial application is opened by the user, tutorial framework 202 accesses the corresponding tutorial content 204 and parses the tutorial flow content 216 into the navigational hierarchy schema, one example which is represented in FIG. 4, and a concrete example of which is shown in Appendix A. As discussed above, once the flow content is parsed into the navigational hierarchy schema, it not only defines the flow of the tutorial, but it also references the screen shots 218 which are to be displayed at each step in the tutorial flow. Parsing the flow content into the navigation hierarchy is indicated by block 322 in FIG. 3.

The tutorial framework 202 then displays a user interface element to user 214 through user interface 212 that allows the user to start the tutorial. For instance, tutorial framework 202 may display at user interface 212 a start button which can be actuated by the user by simply saying “start” (or another similar phrase) or using a point and click device. Of course, other ways of starting the tutorial application running can be used as well. User 214 then starts the tutorial running. This is indicated by blocks 324 and 326 in FIG. 3.

Tutorial framework 202 then runs the tutorial, interactively prompting the user for speech data and simulating, with the screenshots, what happens when the commands which the user has been prompted for are received by the speech recognition system for which the tutorial is being run. This is indicated by block 328 in FIG. 3. Before continuing with the description of the operation shown in FIG. 3, a number of exemplary screenshots will be described to give a better understanding of how a tutorial might operate.

FIGS. 5-11 are exemplary screenshots. FIG. 5 illustrates that, in one exemplary embodiment, screenshot 502 includes a tutorial portion 504 that provides a written tutorial describing the operation of the speech recognition system for which the tutorial application is written.

The screenshot 502 in FIG. 5 also shows a portion of the navigation hierarchy 200 (shown in FIG. 4) which is displayed to the user. A plurality of topic buttons 506-516 located along the bottom of the screenshot shown in FIG. 5 identify the topics in the tutorial application being run. Those topics include “Welcome”, “Basics”, “Dictation”, “Commanding”, etc. When one of the topic buttons 506-516 is selected, a plurality of chapter buttons are displayed.

More specifically, FIG. 5 illustrates a Welcome page corresponding to Welcome button 506. When the user has read the tutorial information on the Welcome page, the user can simply actuate the Next button 518 on screenshot 502 in order to advance to the next screen.

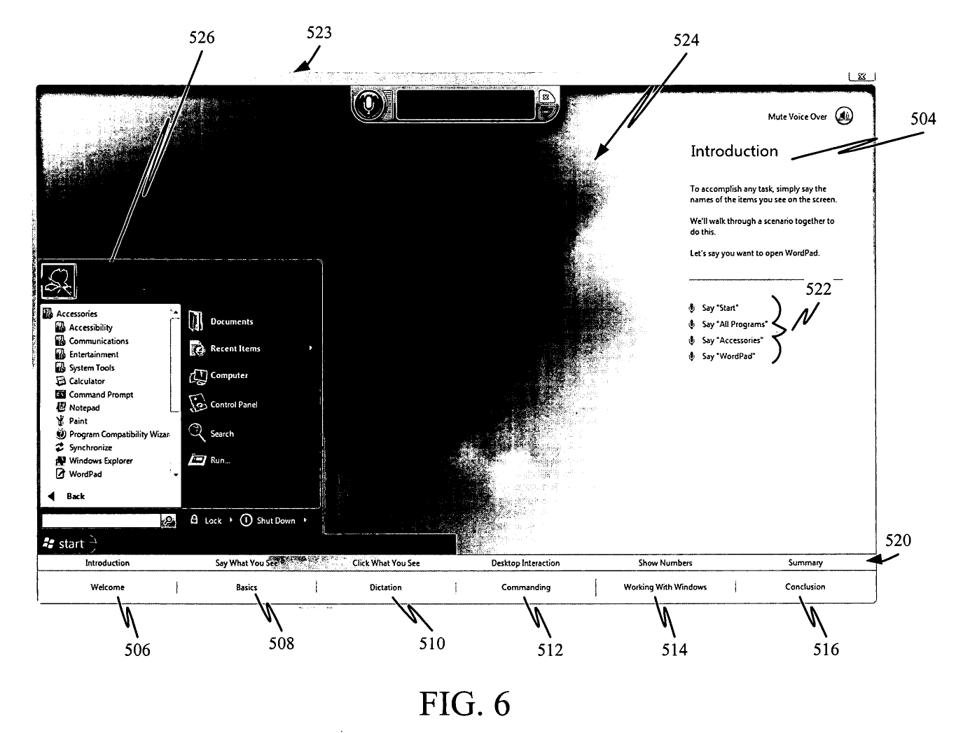

FIG. 6 shows a screenshot 523 similar to that shown in FIG. 5 accept that it illustrates that each topic button 506-516 has a corresponding plurality of chapter buttons. For instance, FIG. 6 shows that Commanding topic button 512 has been actuated by the user. A plurality of chapter buttons 520 are then displayed that correspond to the Commanding topic button 512. The exemplary chapter buttons 520 include “Introduction”, “Say What You See”, “Click What You See”, “Desktop Interaction”, “Show Numbers”, and “Summary”. The chapter buttons 520 can be actuated by the user in order to show one or more pages. In FIG. 6, the “Introduction” chapter button 520 has been actuated by the user and a brief tutorial is shown in the tutorial portion 504 of the screenshot.

Below the tutorial portion 504 are a plurality of steps 522 which can be taken by the user in order accomplish a task. As the user takes the steps 522, a demonstration portion 524 of the screenshot demonstrates what happens in the speech recognition program when those steps are taken. For example, when the user says “Start”, “All Programs”, “Accessories”, the demonstration portion 524 of the screenshot displays the display 526 which shows that the “Accessories” programs are displayed. Then, when the user says “WordPad”, the display shifts to show that the “WordPad” application is opened.

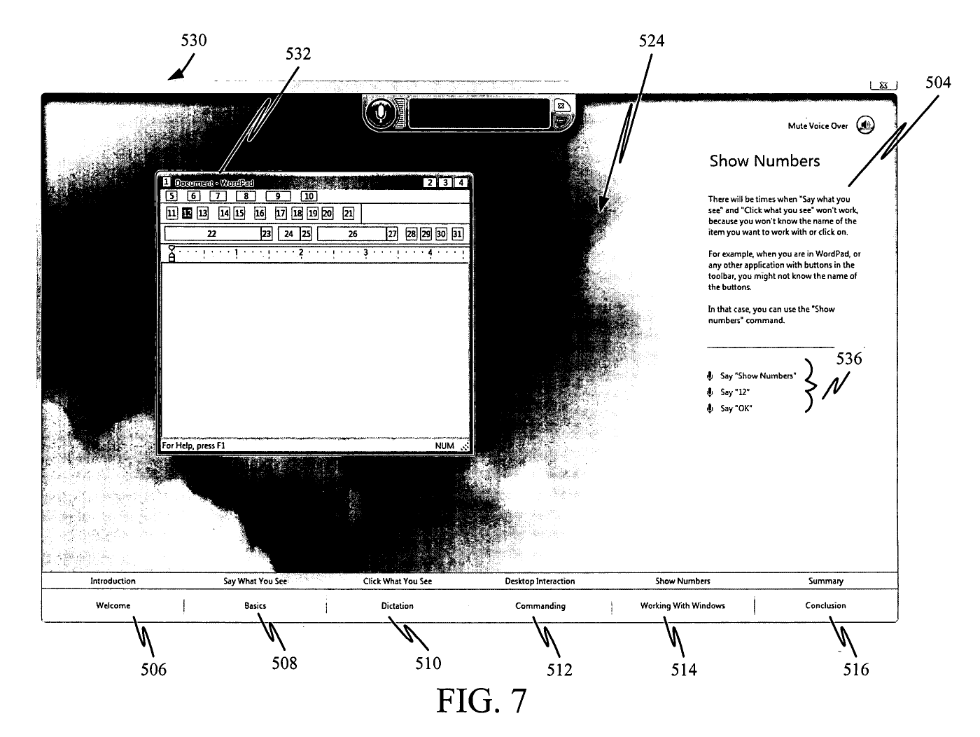

FIG. 7 illustrates another exemplary screenshot 530 in which the “WordPad” application has already been opened. The user has now selected the “Show Numbers” chapter button. The information in the tutorial portion 504 of the screenshot 530 is now changed to information which corresponds to the “Show Numbers” features of the application for which the tutorial has been written. Steps 522 have also been changed to those corresponding to the “Show Numbers” chapter. In the exemplary embodiment, the actuatable buttons or features of the application being displayed in display 532 of the demonstration portion 524 are each assigned a number, and the user can simply say the number to indicate or actuate the buttons in the application.

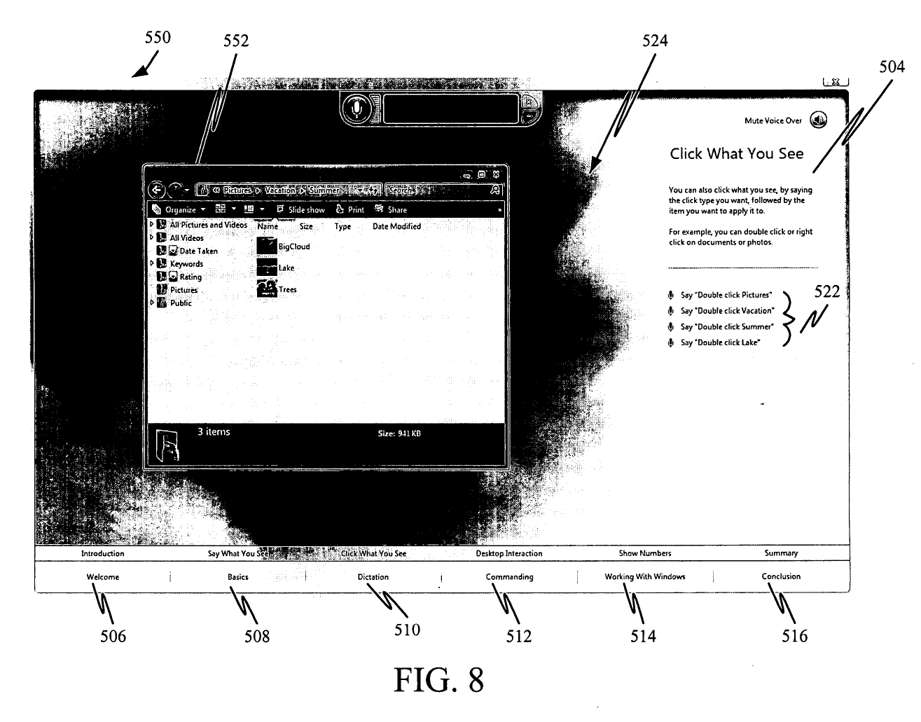

FIG. 8 is similar to FIG. 7 except that the screenshot 550 in FIG. 8 corresponds to user selection of the “Click What You See” chapter button corresponding to the “Commanding” topic. Again, the tutorial portion 504 of the screenshot 550 includes tutorial information regarding how to use the speech recognition system to “click” something on the user interface. A plurality of steps 522 corresponding to that chapter are also listed. Steps 522 walk the user through one or more examples of “clicking” on something on a display 552 in demonstration portion 524. The demonstration display 552 is updated to reflect what would actually be seen by the user if the user were indeed commanding the application using the commands in steps 522, through the speech recognition system.

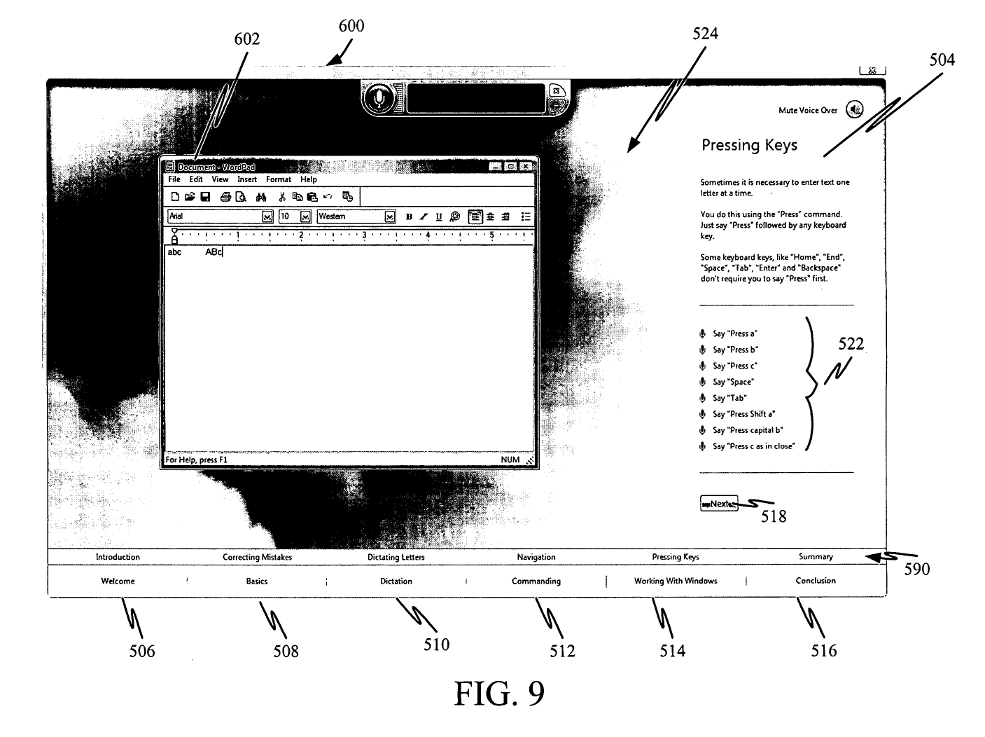

FIG. 9 shows another screenshot 600 which corresponds to the user selecting the “Dictation” topic button 510 for which a new, exemplary, set of chapter buttons 590 is displayed. The new set of exemplary chapter buttons include: “Introduction”, “Connecting Mistakes”, “Dictating Letters”, “Navigation”, “Pressing Keys”, and “Summary”. FIG. 9 shows that the user has actuated the “Pressing Keys” chapter button 603. Again, the tutorial portion 504 of the screenshot shows tutorial information indicating how letters can be entered one at a time into the WordPad application shown in demonstration display 602 on demonstration portion 524 of screenshot 600. Below the tutorial portion 504 are a plurality of steps 522 which the user can take in order to enter individual letters, into the application, using speech. The demonstration display 602 of screenshot 600 is updated after each step 522 is executed by the user, just as would appear if the speech recognition system were used to control the application.

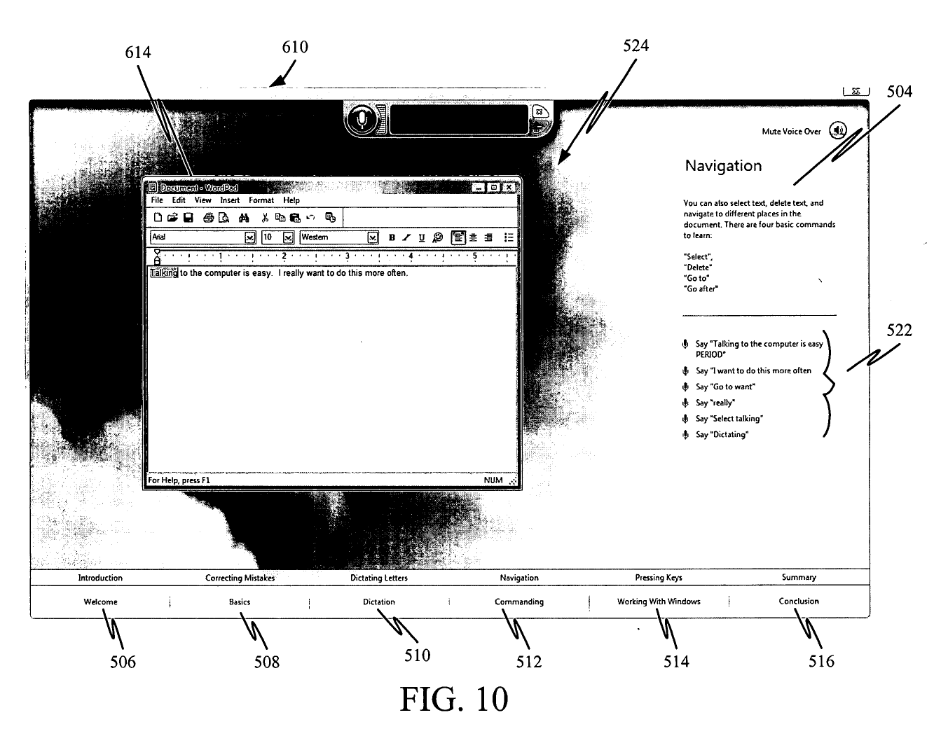

FIG. 10 also shows a screenshot 610 corresponding to the user selecting the Dictation topic button 510 and the “Navigation” chapter button. The tutorial portion 504 of the screenshot 610 now includes information describing how navigation works using the speech dictation system to control the application. Also, the steps 522 are listed which walk the user through some exemplary navigational commands. Demonstration display 614 of demonstration portion 524 is updated to reflect what would be shown if the user were actually controlling the application, using the commands shown in steps 522, through the speech recognition system.

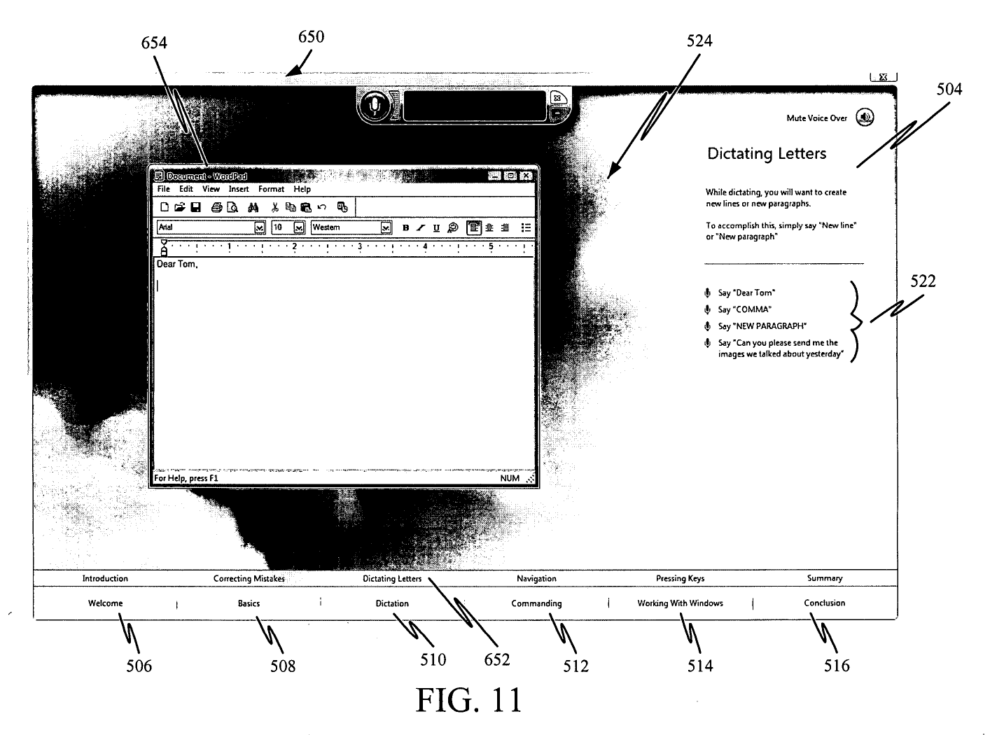

FIG. 11 is similar to that shown in FIG. 10, except that the screenshot 650 shown in FIG. 11 corresponds to user actuation of the “Dictating Letters” chapter button 652. Tutorial portion 504 thus contains information instructing the user how to use certain dictation features, such as creating new lines and paragraphs in a dictation application, through the speech recognition system. Steps 522 walk the user through an example of how to create a new paragraph in a document in a dictation application. Demonstration display 654 in demonstration portion 524 of screenshot 650 is updated to show what the user would see in that application, if the user were actually entering the commands in steps 522 through the speech recognition system.

All of the speech information recognized in the tutorial is provided to speech recognition training system 210 to better train speech recognition system 208.

It should be noted that, at each step 522 in the tutorial, when the user is requested to say a word or phrase, the framework 202 is configured to accept only a predefined set of responses to the prompts for speech data. In other words, if the user is being prompted to say “start”, framework 202 may only be configured to accept a speech input from the user which is recognized as “start”. If the user inputs any other speech data, framework 202 will illustratively provide a screenshot illustrating that the speech input was unrecognized.

Tutorial framework 202 may also illustratively show what happens in the speech recognition system when a speech input is unrecognized. This can be done in a variety of different ways. For instance, tutorial framework 202 can, itself, be configured to only accept predetermined speech recognition results from speech recognition system 208 in response to a given prompt. If the recognition results do not match those allowed by tutorial framework 202, then tutorial framework 202 can provide interactive tutorial information through user interface component 212 to user 214, indicating that the speech was unrecognized. Alternatively, speech recognition system 208 can, itself, be configured to only recognize the predetermined set of speech inputs. In that case, only predetermined rules may be activated in speech recognition system 208, or other steps can be taken to configure speech recognition system 208 such that it does not recognize any speech input outside of the predefined set of possible speech inputs.

In any case, allowing only a predetermined set of speech inputs to be recognized at any given step in the tutorial process provides some advantages. It keeps the user on track in the tutorial, because the tutorial application will know what must be done next, in response to any of the given predefined speech inputs which are allowed at the step being processed. This is in contrast to some prior systems which allowed recognition of substantially any speech input from the user.

Referring again to the flow diagram in FIG. 3, accepting the predefined set of responses for prompts for speech data is indicated by block 330.

When speech recognition system 208 provides recognition results 234 to tutorial framework 202 indicating that an accurate, and acceptable, recognition has been made, then tutorial framework 202 provides the user speech data 232 along with the recognition result 234 (which is illustratively a transcription of the user speech data 232) to speech recognition training system 210. Speech recognition training system 210 then uses the user speech data 232 and the recognition result 234 to better train the models in speech recognition system 208 to recognize the user's speech. This training can take any of a wide variety of different known forms, and the particular way in which the speech recognition system training is done does not form part of the invention. Performing speech recognition training using the user speech data 232 and the recognition result 234 is indicated by block 332 in FIG. 3. As a result of this training, the speech recognition system 208 is better able to recognize the current user's speech.

The schema has a variety of features which are shown in the example set out in Appendix A. For instance, the schema can be used to create practice pages which will instruct the user to perform a task, which the user has already learned, without immediately providing the exact instruction of how to do so. This allows the user to attempt to recall the specific instruction and enter the specific command without being told exactly what to do. This enhances the learning process.

By way of example, as shown in Appendix A, a practice page can be created by setting a “practice=true” flag in the <page> token. This is done as follows:

<page title=“stop listening” practice=“true”>

This causes the <instruction> under the “step” token not to be shown unless a timeout occurs (such as 30 seconds) or unless the speech recognizer 208 obtains a mis-recognition from the user (i.e., the user says the wrong thing).

As a specific example, where the “page title” is set to “stop listening” and the “practice flag” is set to “true”, the display may illustrate the tutorial language:

“During the tutorial, we will sometimes ask you to practice what you have just learned. If you make a mistake, we will help you along. Do you remember how to show the context menu, or right click menu for the speech recognition interface? Try showing it now!”

This can, for instance, be displayed in the tutorial section 504, and the tutorial can then simply wait, listening for the user to say the phrase “show speech options”. In one embodiment, once the user says the proper speech command, then the demonstration display portion 524 is updated to show what would be seen by the user if that command were actually given to the application.

However, if the user has not entered a speech command after a predetermined timeout period, such as 30 seconds or any other desirable timeout, or if the user has entered an improper command, which will not be recognized by the speech recognition system, then the instruction is displayed: “try saying ‘show speech options’”.

It can thus be seen that the present invention combines the tutorial and speech training processes in a desirable way. In one embodiment, the system is interactive in that it shows the user what happens with the speech recognition system when the commands for which the user is prompted are received by the speech recognition system. It also confines the possible recognitions at any step in the tutorial to a predefined set of recognitions in order to make speech recognition more efficient in the tutorial process, and to keep the user in a controlled tutorial environment.

It will also be noted that the tutorial system 200 is easily extensible. In order to provide a new tutorial for new speech commands or new speech functionality, a third party simply needs to author the tutorial flow content 216 and screenshots 218, and they can be easily plugged into framework 202 in tutorial system 200. This can also be done if the third party wishes to create a new tutorial for existing speech commands or functionality, or if the third party wishes to simply alter exiting tutorials. In all of these cases, the third party simply needs to author the tutorial content, with referenced screenshots (or other display elements) such that it can be parsed into the tutorial schema used by tutorial framework 202. In the embodiment discussed herein, that schema is a hierarchical schema, although other schemas could just as easily be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of training a speech recognition system, comprising:
displaying one of a plurality of tutorial displays, the tutorial displays including a prompt, prompting a user to say commands used to control the speech recognition system;
providing received speech data, received in response to the prompt, to the speech recognition system for recognition, to obtain a recognition result;
if the speech recognition result corresponds to one of a predefined subset of possible commands, then training the speech recognition system based on the speech recognition result and the received speech data; and
displaying another of the tutorial displays based on the recognition result.

2. The method of claim 1 wherein displaying another of the plurality of tutorial displays comprises:
displaying a simulation indicative of an actual display generated when the speech recognition system receives the command corresponding to the speech recognition result.

3. The method of claim 2 wherein displaying one of the tutorial displays comprises:
displaying tutorial text describing a feature of the speech recognition system.

4. The method of claim 2 wherein displaying one of the tutorial displays, including a prompt, comprises:
displaying a plurality of steps, each step prompting the user to say a command, the plurality of steps being performed to complete one or more tasks with the speech recognition system.

5. The method of claim 4 wherein displaying one of the tutorial displays comprises:
referring to tutorial content for a selected application.

6. The method of claim 5 wherein the tutorial content comprises navigational flow content and corresponding displays, and wherein displaying one of the tutorial displays comprises:
accessing the navigational flow content, wherein the navigational flow content conforms to a predefined schema and refers to the corresponding displays at different points;
following a navigational flow defined by the navigational flow content; and
displaying the displays referred to at different points in the navigational flow.

7. The method of claim 6 and further comprising:
configuring the speech recognition system to recognize only the predefined subset of the possible commands corresponding to the steps for which the user is prompted by a display that is currently displayed.

8. A speech recognition training and tutorial system, comprising:
tutorial content comprising navigational flow content, indicative of a navigational flow of a tutorial application, and corresponding display elements referred to at different points in navigational flow defined by the navigational flow content, the display elements prompting a user to speak a command, and the display elements further comprising a simulation of a display generated in response to a speech recognition system receiving the command; and
a tutorial framework configured to access the tutorial content and display the display elements according to the navigational flow, the tutorial framework being configured to provide speech information, provided in response to the prompt, to a speech recognition system for recognition, to obtain a recognition result, and to train the speech recognition system based on the recognition result.

9. The speech recognition training and tutorial system of claim 8 wherein the tutorial framework configured the speech recognition system to recognize only a set of expected commands given the display element being displayed.

10. The speech recognition training and tutorial system of claim 8 wherein the tutorial framework is configured to access one of a plurality of different sets of tutorial content based on a selected tutorial application, selected by the user.

11. The speech recognition training and tutorial system of claim 10 wherein the plurality of different sets of tutorial content are pluggable into the tutorial framework.

12. The speech recognition training and tutorial system of claim 8 wherein the navigational flow content comprises a navigation arrangement indicative of how tutorial information is arranged and how navigation through the tutorial information is permitted.

13. The speech recognition training and tutorial system of claim 12 wherein the flow content comprises a navigational hierarchy.

14. The speech recognition training and tutorial system of claim 13 wherein the navigational hierarchy includes hierarchically arranged topics, chapters, pages and steps.

15. A computer readable, tangible medium storing a data structure having computer readable data, the data structure comprising:
a flow portion including computer readable flow data, the flow data defining a navigational flow for a tutorial application for a speech recognition system and conforming to a predefined flow schema; and
a display portion including computer readable display data, the display data defining a plurality of displays referenced by the flow data at different points in the navigational flow defined by the flow data, the display data prompting a user for speech data indicative of commands used in the speech recognition system, the displays showing what is displayed when the speech recognition system receives the speech data input by the user.
